(19) United States
(12) Patent Application Publication
(10) Pub. No.: US 2023/0323739 A1
(43) Pub. Date: Oct. 12, 2023

(54) BULKHEAD

(71) Applicant: DynaEnergetics Europe GmbH, Troisdorf (DE)

(72) Inventor: Christian Eitschberger, Munich (DE)

(73) Assignee: DynaEnergetics Europe GmbH, Troisdorf (DE)

(21) Appl. No.: 18/336,830

(22) Filed: Jun. 16, 2023

Related U.S. Application Data
(63) Continuation of application No. 17/677,478, filed on Feb. 22, 2022, now Pat. No. 11,713,625.
(60) Provisional application No. 63/155,902, filed on Mar. 3, 2021.

(51) Int. Cl. E21B 17/02; E21B 33/10

(52) U.S. Cl. CPC E21B 17/028; E21B 33/10

(57) ABSTRACT

A bulkhead may include a fixed body having a first contact surface and an exterior fixed body surface, a first electrical contact, and a first spring having a first spring end in contact with the first contact surface and a second spring end in contact with the first electrical contact.

### CROSS-REFERENCE TO RELATED APPLICATIONS

This application is a continuation application of U.S. application Ser. No. 17/677,478 filed Feb. 22, 2022, which claims the benefit of U.S. Provisional Patent Application No. 63/155,902 filed Mar. 3, 2021, the entire contents of each of which are incorporated herein by reference.

### BACKGROUND OF THIS DISCLOSURE

Bulkheads may be used in wellbore tool strings to provide electrical connection between segments of the perforating tool string, and they may also provide a seal against fluid and/or pressure between segments of the wellbore tool string.

Exemplary embodiments of bulkheads may use sealing elements, such as O-rings that are provided on either or both of an interior conductive body and an exterior bulkhead body, or bulkhead covers formed of a material capable of creating a fluid and/or pressure seal. However, reliance on multiple sealing elements can increase the possible points of failure from a hydraulic sealing point of view. Further, reliance on the bulkhead cover for pressure and/or fluid sealing limits the range of materials that can be used, therefore increasing manufacturing costs.

In order to reduce manufacturing costs and improve performance reliability, there may be a need for a simplified bulkhead requiring less material and/or parts, as well as less expensive manufacturing methods for the constituent parts, while still allowing ease of use of the device in practical application. Additionally, in order to improve reliability of the wellbore tool string, there may be a need for a bulkhead with dampening and/or shock absorption features to reduce damage to the wellbore perforating tool string and maintain electrical communication during wellbore operations. Further, in order to provide electrical connection to a range of wellbore tools, there may be a need for a bulkhead with a first electrical contact configured for connection to an up-hole tool, and a second electrical contact configured for electrical connection to a downhole tool.

### BRIEF DESCRIPTION OF THE EXEMPLARY EMBODIMENTS

An exemplary embodiment of a bulkhead may include a fixed body having a first contact surface and an exterior fixed body surface, a seal element provided on the exterior fixed body surface, a first electrical contact, a first spring having a first spring end in contact with the first contact surface and a second spring end in contact with the first electrical contact, and a first cover having a first large region having a first large region inner diameter and a first small region having a first small region inner diameter. The first large region inner diameter may be larger than the first small region inner diameter. The fixed body, the first electrical contact, and the first spring may be inserted through the first cover such that the first electrical contact protrudes through the first small region and a portion of the first large region surrounds a first fixed body portion of the fixed body. A first contact maximum outer diameter of the first electrical contact may be larger than the first small region inner diameter of the first small region.

An exemplary embodiment of a bulkhead may include a fixed body having a first contact surface; a first electrical contact; and a first spring having a first spring end in contact with the first contact surface and a second spring end in contact with the first electrical contact. The first electrical contact may include a first contact hollow interior and a first contact open end. The second spring end extends through the first contact open end of the first electrical contact into the first contact hollow interior.

### BRIEF DESCRIPTION OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1 is a cross section view of a bulkhead according to an exemplary embodiment;

FIG. 1A is a partial cross section view of a bulkhead according to an exemplary embodiment;

FIG. 2 is a cross section view of a first cover and a first electrical contact according to an exemplary embodiment;

FIG. 3 is a cross section view of a first cover, a second cover, and a fixed body according to an exemplary embodiment;

FIG. 4A is a cross section view of a tandem seal adapter according to an exemplary embodiment;

FIG. 4B is a cross section view of a tandem seal adapter and bulkhead according to an exemplary embodiment;

FIG. 5 is a cross section view of a bulkhead according to an exemplary embodiment

FIG. 6 is a cross section view of a bulkhead according to an exemplary embodiment;

FIG. 7A is a partial cross section view of a first cover and a first electrical contact according to an exemplary embodiment;

FIG. 7B is a partial cross section view of a second cover and a second electrical contact according to an exemplary embodiment;

FIG. 8 is a cross section view of a first cover, a second cover, and a fixed body according to an exemplary embodiment;

FIG. 9A is a cross section view of a top connector tandem seal adapter according to an exemplary embodiment;

FIG. 9B is a cross section view of a top connector tandem seal adapter and bulkhead according to an exemplary embodiment; and

FIG. 10 is a cross section view of a collar, a top connector tandem seal adapter, and a bulkhead according to an exemplary embodiment.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to emphasize specific features relevant to some embodiments.

### DETAILED DESCRIPTION

Reference will now be made in detail to various exemplary embodiments. Each example is provided by way of explanation and is not meant as a limitation and does not constitute a definition of all possible embodiments.

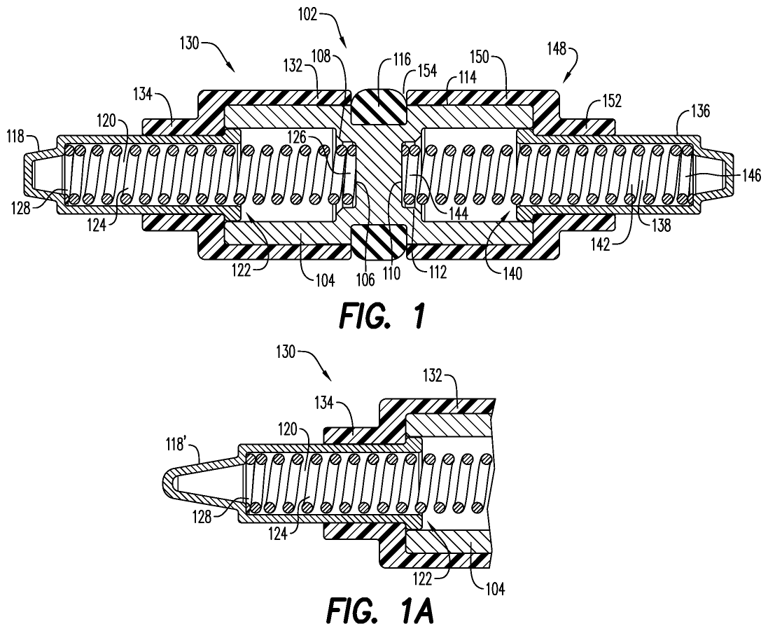

FIG. 1 shows an exemplary embodiment of a bulkhead 102. The bulkhead 102 may include a fixed body 104, a seal element 116, a first electrical contact 118, a second electrical contact 136, a first spring 124, a second spring 142, and a cover (i.e., a first cover 130, and a second cover 148).

The fixed body 104 may be formed of an electrically conductive material and may include a first contact surface 106, a second contact surface 110 opposite to the first contact surface 106, and an exterior fixed body surface 114. The seal element 116 may be provided on the exterior fixed body surface 114. A first chamfered edge 108 may be formed adjacent to the first contact surface 106. Similarly, a second chamfered edge may be provided adjacent to the second contact surface 110. In an exemplary embodiment, the first chamfered edge 108 and the second contact surface 110 may be rounded instead of chamfered.

The first electrical contact 118 may be formed of an electrically conductive material, and may include a first contact hollow interior 120 and a first open end 122. Similarly, the second electrical contact 136 may be formed of an electrically conductive material, and may include a second contact hollow interior 138 and a second open end 140. The first electrical contact 118 and the second electrical contact 136 may be formed by a deep drawn molding method or other suitable method that allows formation of a hollow part. The first electrical contact 118 and the second electrical contact 136 may be formed in any size, shape, or dimension suitable for providing an electrical connection to an adjacent electrically conductive component. For example, with reference to FIG. 1, the first electrical contact 118 may be formed with a flattened hollow tip. In an exemplary embodiment shown in FIG. 1A, the first electrical contact 118′ may be formed with a pointed hollow tip. However, it will be understood that the size, shape, or dimension of the first electrical contact 118 and the second electrical contact 136 are not limited to these examples, and that other sizes, shapes, or dimensions are possible.

The first spring 124 may be formed of an electrically conductive material. A first spring end 126 of the first spring 124 may be in contact with the first contact surface 106 of the fixed body 104. The first spring 124 may extend through the first open end 122 of the first electrical contact 118 such that a second spring end 128 of the first spring 124 may be in contact with the first electrical contact 118 within the first contact hollow interior 120.

Similarly, the second spring 142 may be formed of an electrically conductive material. A third spring end 144 of the second spring 142 may be in contact with the second contact surface 110 of the fixed body 104. The second spring 142 may extend through the second open end 140 of the second electrical contact 136 such that a fourth spring end 146 of the second spring 142 may be in contact with the second electrical contact 136 within the second contact hollow interior 138. In this way, the first electrical contact 118, the first spring 124, the fixed body 104, the second spring 142, and the second electrical contact 136 may be in mutual electrical communication with each other.

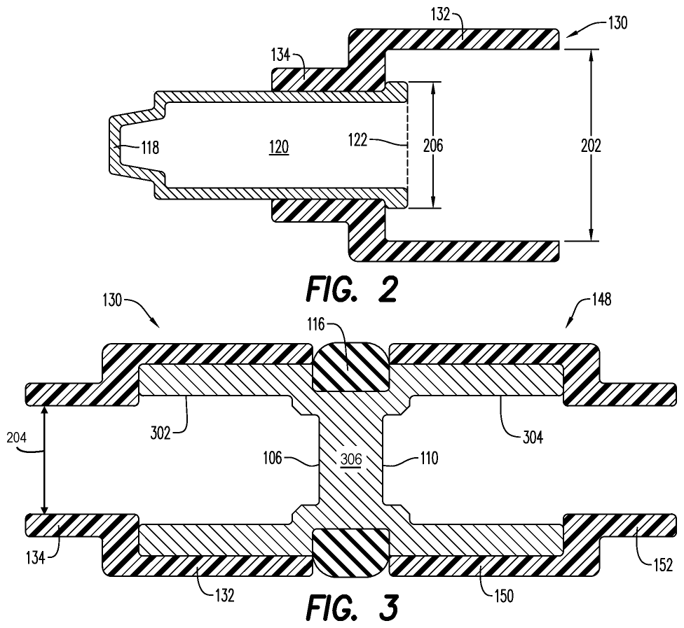

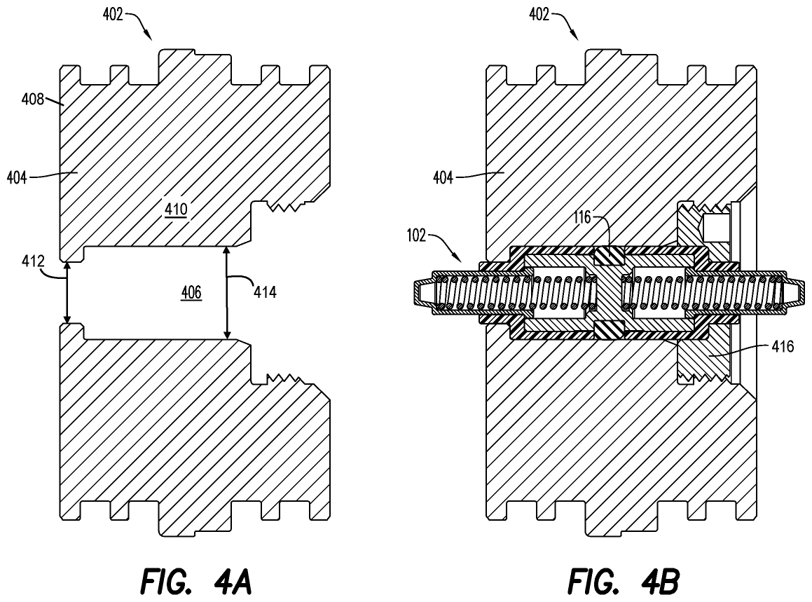

The first cover 130 may include a first large region 132 having a first large region inner diameter 202 and a first small region 134 having a first small region inner diameter 204 (see FIG. 3). As further seen in FIG. 2, the first large region inner diameter 202 may be larger than the first small region inner diameter 204. The first cover 130 may be formed of an electrically non-conductive material such as plastic, ceramic, glass, wood, thermoplastic, or other suitable non-conductive material. In an aspect, the first cover 130 may be formed of a polyamide material, for example, Polyamide 6, Nylon 6, or polycaprolactam (PA6).

Similarly, the second cover 148 may include a second large region 150 having a second large region inner diameter and a second small region 152 having a second small region inner diameter. Similar to the relationship illustrated between the first large region inner diameter 202 and the first small region inner diameter 204 in FIGS. 2 and 3, the second large region inner diameter may be larger than the second small region inner diameter. The second cover 148 may be formed of an electrically non-conductive material such as plastic, ceramic, glass, wood, thermoplastic, or other suitable non-conductive material. In an aspect, the second cover 148 may be formed of a polyamide material, for example, Polyamide 6, Nylon 6, or polycaprolactam (PA6).

The first cover 130 and the second cover 148 may be fixed to the fixed body 104. For example, the first cover 130 and the second cover 148 may be press fit to the fixed body 104, attached to the fixed body 104 via a glue, epoxy, or other adhesive, or threadedly engaged with the fixed body 104 via mutually complementary threads. However, it will be understood that the affixation of the first cover 130 and the second cover 148 to the fixed body 104 are not limited to these examples, and that other methods of affixation are possible.

FIG. 1 further shows that there may be a gap 154 between the first cover 130 and the second cover 148 through which the seal element 116 may protrude. In this way, the first cover 130 and the second cover 148 may prevent flow or movement of the seal element 116. In other words, the first cover 130 and the second cover 148 may help to maintain the seal element 116 in the proper position.

It will be understood that the depiction of the first cover 130 and the second cover 148 is not intended to be limited in terms of the composition or number of parts in the structure(s) surrounding the fixed body 104. For example, the first cover 130 and the second cover 148 may be collectively referred to as a single cover. Alternatively, the first cover 130 and the second cover 148 may be replaced by a single cover. In this case, the seal element 116 may protrude through the gap 154 in the cover. Alternatively still, there may be more than two covers in an exemplary embodiment where there is more than one seal element 116.

The fixed body 104, the first electrical contact 118, and the first spring 124 may be inserted through the first cover 130 such that the first electrical contact 118 protrudes through the first small region 134 of the first cover 130. Further, a portion of the first large region 132 may surround a first fixed body portion 302 of the fixed body 104 (see FIG. 3). Similarly, the fixed body 104, the second electrical contact 136, and the second spring 142 may be inserted through the second cover 148 such that the second electrical contact 136 protrudes through the second small region 152 of the second cover 148. Further, a portion of the second large region 150 may surround a second fixed body portion 304 of the fixed body 104 (see FIG. 3). A third fixed body portion 306 of the fixed body 104 may be provided between the first fixed body portion 302 and the second fixed body portion 304. The third fixed body portion 306 may be formed of a solid piece of electrically conductive material configured to provide an electrical connection between the first contact surface 106 and the second contact surface 110. In an aspect, the seal element 116 may be provided on the exterior fixed body surface 114 defined by the third fixed body portion 306.

The first electrical contact 118 may have a first contact maximum outer diameter 206. The first contact maximum outer diameter 206 may be larger than the first small region inner diameter 204. Thus, the first electrical contact 118 may be retained within the first cover 130. Similarly, the second electrical contact 136 may have a second contact maximum outer diameter. Similar to the relationship between the first small region inner diameter 204 and the first contact maximum outer diameter 206 shown in FIG. 2, the second contact maximum outer diameter may be larger than the second small region inner diameter. Thus, the second electrical contact 136 may be retained within the second cover 148. In an aspect, the first contact maximum outer diameter 206 may be the same as or different (i.e., smaller or larger) than the second contact maximum outer diameter.

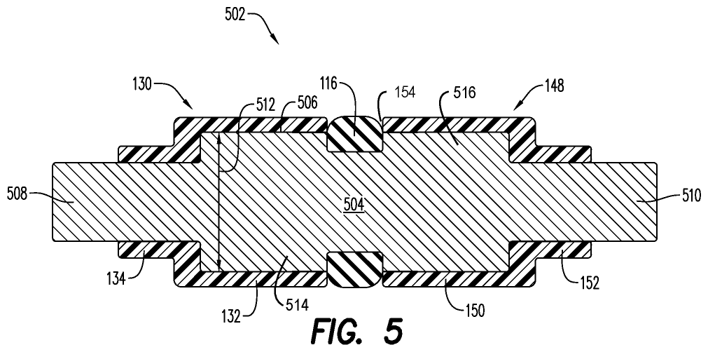

FIG. 4A and FIG. 4B show an exemplary embodiment of a tandem seal adapter (TSA) 402. The tandem seal adapter 402 may include a TSA body 404 and a bore 406 extending through the TSA body 404. As seen in FIG. 4B, the bulkhead 102 may be provided within the bore 406. The TSA body 404 may include a first body portion 408 having a first bore inner diameter 412 and a second body portion 410 having a second bore inner diameter 414. The second bore inner diameter 414 may be larger than the first bore inner diameter 412. The first large region 132 of the first cover 130 and the second large region 150 of the second cover 148 (see FIG. 3) may have a cover maximum outer diameter that is larger than the first bore inner diameter 412. Thus, the bulkhead 102 may be retained within the TSA body 404. The seal element 116 of the bulkhead 102 may be in contact with the TSA body 404 (i.e., with the second body portion 410) in order to form a seal that prevents transfer of fluid and/or pressure through the tandem seal adapter 402. The bulkhead 102 may be secured in the tandem seal adapter 402 via a retainer nut 416 or other suitable structure.

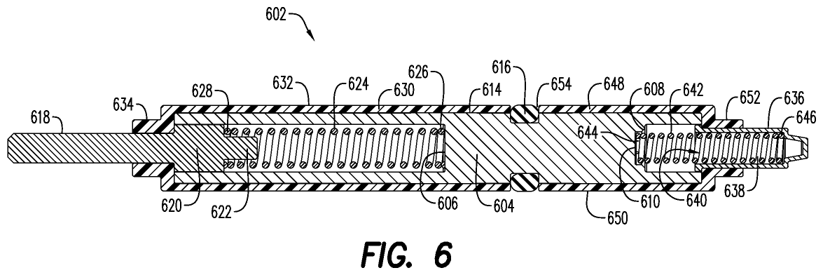

FIG. 5 shows another exemplary embodiment of a bulkhead 502. The bulkhead 502 may include a fixed body 504, the seal element 116, the first cover 130, and the second cover 148. The fixed body 504 may be formed of a conductive material as an integral and monolithic piece extending through the bulkhead 502. The fixed body 504 may include an exterior fixed body surface 506, and the seal element 116 may be provided on the exterior fixed body surface 506 in a gap 154 formed between the first cover 130 and the second cover 148. The fixed body 504 may further include a first contact protrusion 508 that extends through the first small region 134 of the first cover 130 and a second contact protrusion 510 that extends through the second small region 152 of the second cover 148. A portion of the first large region 132 of the first cover 130 may surround a first fixed body portion 514 of the fixed body 504, and a portion of the second large region 150 of the second cover 148 may surround a second fixed body portion 516 of the fixed body 504. The fixed body 504 may have a fixed body maximum diameter 512 that is larger than the first small region inner diameter 204 (see FIG. 2) and the second small region inner diameter.

In an alternative perspective, the fixed body 504, the first contact protrusion 508, and the second contact protrusion 510 may be considered as separate components, i.e., as a first electrical contact, the fixed body 504, and a second electrical contact, all in mutual electrical communication with each other, and providing electrical communication through the bulkhead 502.

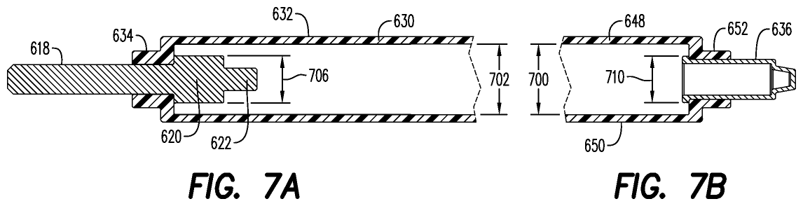

FIG. 6 shows an exemplary embodiment of a bulkhead 602. The bulkhead 602 may include a fixed body 604, a seal element 616, a first electrical contact 618, a second electrical contact 636, a first spring 624, a second spring 642, and a cover (i.e., a first cover 630, and a second cover 648).

The fixed body 604 may be formed of an electrically conductive material and may include a first contact surface 606, a second contact surface 610 opposite to the first contact surface 606, and an exterior fixed body surface 614. The seal element 616 may be provided on the exterior fixed body surface 614. As shown in the exemplary embodiment, the first contact surface 606 may be provided as a flat, planar surface with no adjacent chamfering or curvature such that the first contact surface 606 is perpendicular to a neighboring inner wall of the fixed body 604. A chamfered edge 608 may be provided adjacent to the second contact surface 610. In an aspect, one or each of the first contact surface 606 and the second contact surface 610 may be formed as a flat, planar surface. Alternatively, a chamfered edge may be formed adjacent to the first contact surface 606. In a further embodiment, one or each of the first contact surface 606 and the second contact surface 610 may be rounded or curved.

The first electrical contact 618 may be formed of an electrically conductive material, and may be formed as a solid, monolithic component. The first electrical contact 618 may be formed by machining processes such as computerized numerical control (CNC) machining, 3-D milling, or other metal machine processes. The first electrical contact 618 may include a first contact body 620 and a first contact end 622 and be configured such that the first electrical contact 618, the first spring 624, and the fixed body 604 are in mutual electrical communication with each other.

The first spring 624 may be formed of an electrically conductive material. A first spring end 626 of the first spring 624 may be in contact with the first contact surface 606 of the fixed body 604. The first spring 624 may be positioned to receive and retain the first contact end 622 of the first electrical contact 618 within an interior space of the first spring 624 such that a second spring end 628 of the first spring 624 may be in contact with the first electrical contact 618 within an interior space of the fixed body 604. It will be understood that the depiction of the first electrical contact 618 is not intended to be limited in terms of the size, shape, or dimension of the first electrical contact 618. In an alternative embodiment, for example, the first contact end 622 may be a flat surface, or may be formed with an opening in which the second spring end 628 is received. However, it will be understood that the size, shape, or dimension of the first electrical contact 618 is not limited to these examples, and that other sizes, shapes, or dimensions are possible.

The second electrical contact 636 may be formed of an electrically conductive material, and may include a second contact hollow interior 638 and a second contact open end 640. The second electrical contact 636 may be formed by a deep drawn molding method or other suitable method that allows formation of a hollow part.

The second spring 642 may be formed of an electrically conductive material. A third spring end 644 of the second spring 642 may be in contact with the second contact surface 610 of the fixed body 604. The second spring 642 may extend through the second contact open end 640 of the second electrical contact 636 such that a fourth spring end 646 of the second spring 642 may be in contact with the second electrical contact 636 within the second contact hollow interior 638. In this way, the first electrical contact 618, the first spring 624, the fixed body 604, the second spring 642, and the second electrical contact 636 may be in mutual electrical communication with each other.

The first cover 630 and the second cover 648 may be fixed to the fixed body 604. For example, the first cover 630 and the second cover 648 may be press fit to the fixed body 604, attached to the fixed body 604 via a glue, epoxy, or other adhesive, or threadedly engaged with the fixed body 604 via mutually complementary threads. However, it will be understood that the affixation of the first cover 630 and the second cover 648 to the fixed body 604 are not limited to these examples, and that other methods of affixation are possible.

FIG. 6 further shows that there may be a gap 654 between the first cover 630 and the second cover 648 through which the seal element 616 may protrude. In this way, the first cover 630 and the second cover 648 may prevent flow or movement of the seal element 616. In other words, the first cover 630 and the second cover 648 may help to maintain the seal element 616 in the proper position.

It will be understood that the depiction of the first cover 630 and the second cover 648 is not intended to be limited in terms of the composition or number of parts in the structure(s) surrounding the fixed body 604. For example, the first cover 630 and the second cover 648 may be collectively referred to as a single cover. Alternatively, the first cover 630 and the second cover 648 may be replaced by a single cover. In this case, the seal element 616 may protrude through the gap 654 in the cover. Alternatively still, there may be more than two covers in an exemplary embodiment where there is more than one seal element 616.

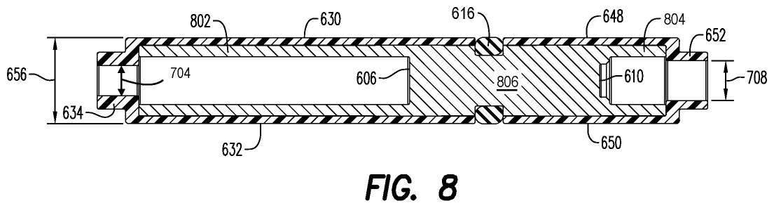

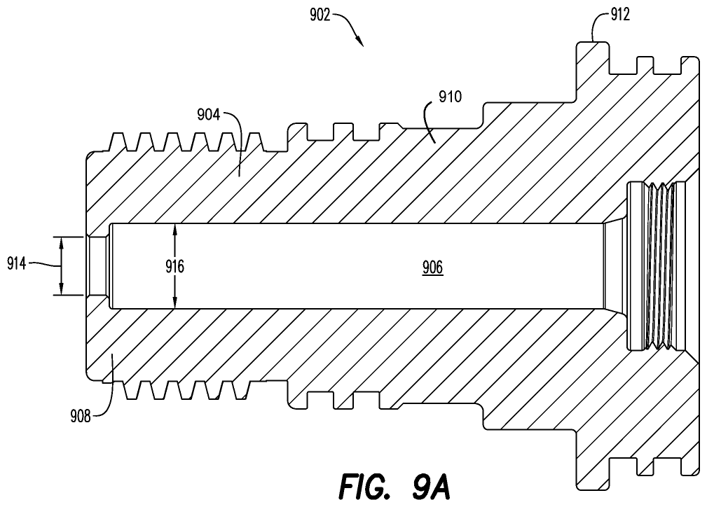

With reference to FIG. 7A, the first cover 630 may include a first large region 632 having a first large region inner diameter 702 and a first small region 634 having a first small region inner diameter 704 (see FIG. 8). The first large region inner diameter 702 may be larger than the first small region inner diameter 704. The first cover 630 may be formed of an electrically non-conductive material such as plastic, ceramic, glass, wood, thermoplastic, or other suitable non-conductive material. In an aspect, the first cover 630 may be formed of a polyamide material, for example, Polyamide 6, Nylon 6, or polycaprolactam (PA6).

Similarly, with reference to FIG. 7B, the second cover 648 may include a second large region 650 having a second large region inner diameter 700 and a second small region 652 having a second small region inner diameter 708 (see FIG. 8). Similar to the relationship illustrated between the first large region inner diameter 702 and the first small region inner diameter 704 in FIGS. 7A and 8, the second large region inner diameter 700 may be larger than the second small region inner diameter 708. The second cover 648 may be formed of an electrically non-conductive material such as plastic, ceramic, glass, wood, thermoplastic, or other suitable non-conductive material. In an aspect, the second cover 648 may be formed of a polyamide material, for example, Polyamide 6, Nylon 6, or polycaprolactam (PA6). In an aspect, the first large region inner diameter 702 may be the same as or different (i.e., smaller or larger) than the second large region inner diameter 700. The first small region inner diameter 704 may be the same as or different (i.e., smaller or larger) than the second small region inner diameter 708.

The first electrical contact 618 may have a first contact maximum outer diameter 706. The first contact maximum outer diameter 706 may be larger than the first small region inner diameter 704. Thus, the first electrical contact 618 may be retained within the first cover 630. Similarly, the second electrical contact 636 may have a second contact maximum outer diameter 710. Similar to the relationship between the first small region inner diameter 704 and the first contact maximum outer diameter 706, the second contact maximum outer diameter 710 may be larger than the second small region inner diameter 708. Thus, the second electrical contact 636 may be retained within the second cover 648. In an aspect, the first contact maximum outer diameter 706 may be the same as or different (i.e., smaller or larger) than the second contact maximum outer diameter 710.

The fixed body 604, the first electrical contact 618, and the first spring 624 may be inserted through the first cover 630 such that the first electrical contact 618 protrudes through the first small region 634 on a first end of the cover 630. Further, a portion of the first large region 632 may surround a first fixed body portion 802 of the fixed body 604 (see FIG. 8). Similarly, the fixed body 604, the second electrical contact 636, and the second spring 642 may be inserted through the second cover 648 such that the second electrical contact 636 protrudes through the second small region 652 on a second end of the cover 648. Further, a portion of the second large region 650 may surround a second fixed body portion 804 of the fixed body 604 (see FIG. 8). A third fixed body portion 806 of the fixed body 604 may be provided between the first fixed body portion 802 and the second fixed body portion 804. The third fixed body portion 806 may be formed of a solid piece of electrically conductive material configured to provide an electrical connection between the first contact surface 606 and the second contact surface 610. The sealing element 616 may be provided on the exterior fixed body surface 614 defined by the third fixed body portion 806.

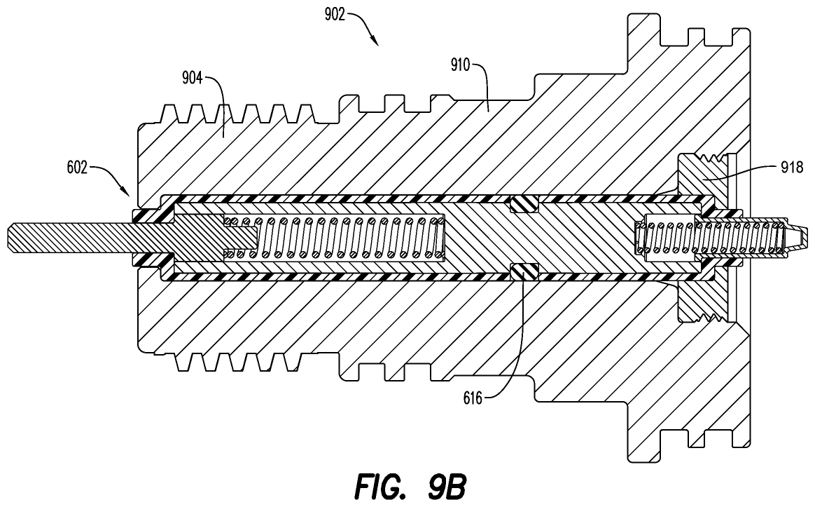

FIG. 9A and FIG. 9B show an exemplary embodiment of a top connector tandem seal adapter (TSA) 902 that may be used as a top connector for electrical connection of a perforating gun to a tool string. The TSA or top connector 902 may include a TSA body 904 and a bore 906 extending through the TSA body 904. As seen in FIG. 9B, the bulkhead 602 may be provided within the bore 906. The TSA body 904 may include a first body portion 908 having a first bore inner diameter 914 and a second body portion 910 having a second bore inner diameter 916. The second bore inner diameter 916 may be larger than the first bore inner diameter 914. The seal element 616 of the bulkhead 602 may be in contact with the TSA body 904 (i.e., with the second body portion 910) in order to form a seal that prevents transfer of fluid and/or pressure through the tandem seal adapter 902.

The first cover 630 and the second cover 648 may have a cover maximum outer diameter 656 (see FIG. 8). The cover maximum outer diameter 656 may be larger than the first bore inner diameter 914. Thus, the bulkhead 602 may be retained within the TSA body 904. The bulkhead 602 may be secured in the tandem seal adapter 902 via a retainer nut 918 or other suitable structure.

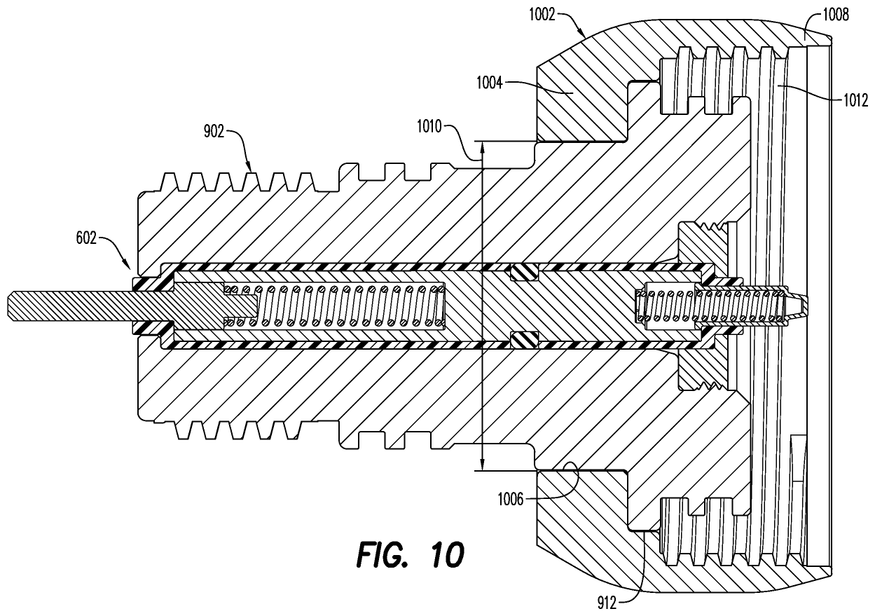

FIG. 10 shows an exemplary embodiment of a bulkhead 602 secured within a tandem seal adapter 902 that is in turn retained in a collar 1002. The collar 1002 may include a collar body 1004, a collar bore 1006 extending through collar body 1004, and a collar open end 1008. The TSA body 904 may include a maximum outer diameter portion 912 (see FIG. 9A) that is larger than a collar inner diameter 1010 defined by the collar bore 1006. Thus, the tandem seal adapter 902 is retained within the collar 1002. In an aspect, the second electrical contact 636 may be positioned adjacent to the collar open end 1008 for electrical contact and connection to an adjacent electrically conductive component. The collar open end 1008 may be configured for connection to an adjacent wireline tool, such as a wireline release tool. In an aspect, the collar open end 1008 may include a threaded interior portion 1012 for engagement with an adjacent wireline tool via mutually complementary threads.

The Figures described above illustrate embodiments with one seal element 116, 616. In some embodiments, there will be one and only one seal element 116, 616, with no other seal elements provided elsewhere on the bulkhead 102, 502, 602. Alternatively, an exemplary embodiment may have more than one seal element 116, 616, provided on the exterior fixed body surface 114, 506, 614 of the fixed body 104, 504, 604. An exemplary embodiment with one and only one seal element 116, 616 may be advantageous in that it can reduce manufacturing costs due to the reduced number of components compared to devices with multiple seal elements. Additionally, using one and only one seal element 116, 616 reduces the possible points of failure from a hydraulic sealing point of view.

The embodiments described above may provide a number of benefits over conventional devices. For example, by placing the seal element 116, 616 directly on the fixed body 104, 604 and protruding through the gap 154, 654, the total number of required sealing elements can be reduced, as compared with conventional devices in which sealing elements may be provided on both an interior conductive body and an exterior bulkhead body. This may help to reduce the overall length of the bulkhead 102, 602, as well as reduce manufacturing costs.

Additionally, because in an exemplary embodiment the first cover 130 and the second cover 148 may not be directly involved with the sealing function of the bulkhead 102, a wider range of materials can be used in making the first cover 130 and the second cover 148. This allows for the selection of cost-effective materials to reduce the overall cost of the bulkhead 102.

The embodiments provided above may be used for electrical connection to various wireline tools to provide a wireline tool string including a bulkhead 102, 502, 602 and tandem seal adapter 402, and/or top connector tandem seal adapter 902, in which a first wireline tool is electrically connected to the first electrical contact 118, 508, 618 and a second wireline tool is electrically connected to the second electrical contact 136, 510, 636. In an aspect, the solid first electrical contact 618 may formed of a size, shape, and dimension that conforms to an industry standard shape, size, or dimension that is well-known for electrical connection with a range of commercially available wellbore tools. The bulkhead 602 may be provided in a wireline tool string top connector tandem seal adapter (e.g., 902) for electrical connection to, for example, a casing collar locator (CCL). The first electrical contact 618 may be oriented up-hole in a tool string to connect to an adjacent up-hole tool, while the second electrical contact 636 may be oriented to electrically connect to a detonator head or another adjacent down-hole tool.

Further, with respect to the first electrical contact 118 and the second electrical contact 136 of the bulkhead 102, the first contact hollow interior 120 provided in the first electrical contact 118 and the second contact hollow interior 138 provided in the second electrical contact 136 allow for a longer travel distance of the first spring 124 and the second spring 142. This increases the dampening effect of the first spring 124 and the second spring 142, especially after the firing of a perforating gun. Additionally, manufacturing costs can be reduced because of the reduced costs associated with the deep drawn method used for making the first electrical contact 118 and the second electrical contact 136. The hollow structure of the first electrical contact 118 and the second electrical contact 136 due to the deep drawn material or non-solid material may allow for a significant collapsible or deformable zone around the first electrical contact 118 and the second electrical contact 136. This may provide significant advantages in that shock impact and potential mechanical damage to a detonator head or other contacting components can be reduced or eliminated. Further, the first chamfered edge 108 and the second chamfered edge 112 may allow the inner ends of the first electrical contact 118 and the second electrical contact 136 to deform in the case of a shock during the firing of perforation guns, thereby improving a dampening effect.

In some embodiments (e.g., FIG. 1), the profile of the end pin of the first electrical contact 118 and/or the second electrical contact 136 may be flattened. In other embodiments (e.g., FIG. 1A), the profile of the end pin of the first electrical contact and/or the second electrical contact 136 may be pointed. A flattened end pin profile may be advantageous in general applications. A pointed end pin profile may be advantageous in applications in which it is desirable to reduce rotational surface friction by the first electrical contact or the second electrical contact against the opposing electrode in an adjacent component to which the first electrical contact or the second electrical contact is electrically connected. This may include, for example, internally rotating or swiveling self-orienting perforating gun systems.

Further, the first contact protrusion 508 and the second contact protrusion 510 of the bulkhead 502 may be configured for electrical connection to an adjacent wireline tool or component that includes its own respective spring-loaded contact. The solid, non-spring-loaded design of the bulkhead fixed body 504 requires connection to an opposite spring-loaded contact, such as a spring-loaded end plate or spring-loaded detonator, as described in U.S. Pat. No. 10,188,990, which is commonly owned by DynaEnergetics Europe GmbH and incorporated herein by reference.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower,” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur-this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine,” “calculate,” and “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

What is claimed is:

1. A bulkhead, comprising:
a fixed body having a first contact surface and an exterior fixed body surface;
a seal element provided on the exterior fixed body surface;
a first electrical contact;
a first spring having a first spring end in contact with the first contact surface and a second spring end in contact with the first electrical contact; and
a first cover having a first large region having a first large region inner diameter and a first small region having a first small region inner diameter, the first large region inner diameter being larger than the first small region inner diameter, wherein
the fixed body, the first electrical contact, and the first spring are inserted through the first cover such that the first electrical contact protrudes through the first small region and a portion of the first large region surrounds a first fixed body portion of the fixed body, and
a first contact maximum outer diameter of the first electrical contact is larger than the first small region inner diameter of the first small region.

2. The bulkhead of claim 1, wherein:
the first electrical contact comprises a first contact hollow interior and a first contact open end; and
the first spring end extends through the first contact open end of the first electrical contact.

3. The bulkhead of claim 1, wherein the second spring end abuts a first interior surface of the first electrical contact.

4. The bulkhead of claim 1, wherein:
the first electrical contact comprises a first contact body and a first contact end, the first contact body comprising a solid piece of material; and
the second spring end of the first spring receives the first contact end of the first electrical contact within an interior of the first spring.

5. The bulkhead of claim 4, wherein:
the fixed body comprises a second contact surface opposite to the first contact surface;
the bulkhead further comprises:
a second electrical contact; and
a second spring having a third spring end in contact with the second contact surface and a fourth spring end in contact with the first electrical contact;
the second electrical contact comprises a second contact body and a second contact end, the second contact body comprising a solid piece of material; and
the fourth spring end of the second spring receives the second contact end of the second electrical contact within an interior of the second spring.

6. The bulkhead of claim 1, wherein the first contact surface comprises a rounded edge.

7. The bulkhead of claim 1, wherein the first contact surface comprises a chamfered edge.

8. The bulkhead of claim 1, wherein:
the fixed body comprises a second contact surface opposite to the first contact surface; and
the bulkhead further comprises:
a second electrical contact having a second contact hollow interior and a second contact open end;
a second spring having a third spring end in contact with the second contact surface and a fourth spring end in contact with the second electrical contact within the second contact hollow interior, the second spring extending through the second contact open end of the second electrical contact; and
a second cover having a second large region having a second large region inner diameter and a second small region having a second small region inner diameter, the second large region inner diameter being larger than the second small region inner diameter; and
the fixed body, the second electrical contact, and the second spring are inserted through the second cover such that the second electrical contact protrudes through the second small region and a portion of the second large region surrounds a second fixed body portion of the fixed body; and
a second contact maximum outer diameter of the second electrical contact is larger than the second small region inner diameter of the second small region.

9. The bulkhead of claim 8, wherein:
the fourth spring end extends through the second contact open end of the second electrical contact.

10. The bulkhead of claim 9, wherein the fourth spring end abuts a second interior surface of the second electrical contact.

11. The bulkhead of claim 8, wherein the seal element protrudes through a gap between the first cover and the second cover.

12. The bulkhead of claim 1, wherein one and only one seal element is provided on the exterior fixed body surface.

13. The bulkhead of claim 8, wherein:
the first electrical contact, the fixed body, and the second electrical contact are in mutual electrical communication.

14. A bulkhead, comprising:
a fixed body having a first contact surface;
a first electrical contact; and
a first spring having a first spring end in contact with the first contact surface and a second spring end in contact with the first electrical contact;
wherein the first electrical contact comprises a first contact hollow interior and a first contact open end; and
the second spring end extends through the first contact open end of the first electrical contact into the first contact hollow interior.

15. The bulkhead of claim 14, wherein the second spring end abuts a first interior surface of the first electrical contact.

16. The bulkhead of claim 14, further comprising:
a second electrical contact having a second contact hollow interior and a second contact open end; and
a second spring having a third spring end in contact with the second contact surface and a fourth spring end in contact with the second electrical contact;
wherein the fourth spring end extends through the second contact open end of the second electrical contact into the second contact hollow interior.

17. The bulkhead of claim 16, wherein the fourth spring end abuts a second interior surface of the second electrical contact.

18. The bulkhead of claim 14, wherein the first contact surface comprises a rounded edge.

19. The bulkhead of claim 14, wherein the first contact surface comprises a chamfered edge.

20. The bulkhead of claim 14, wherein:
the first electrical contact, the fixed body, and the second electrical contact are in mutual electrical communication.
